(19) United States
(12) Patent Application Publication
(10) Pub. No.: US 2022/0144425 A1
(43) Pub. Date: May 12, 2022

(54) UAV and Cable Towing Attachment

(71) Applicant: Baltimore Gas and Electric Company, Baltimore, MD (US)

(72) Inventor: Andrew McCauley, New Freedom, PA (US)

(21) Appl. No.: 17/091,833

(22) Filed: Nov. 6, 2020

(51) Int. Cl. B64C 39/02; B64D 1/22; B66C 1/34

(52) U.S. Cl. CPC B64C 39/024; B64D 1/22; B64C 2201/128; B64C 2201/027; B66C 1/34

(57) ABSTRACT

A combination hook assembly and unmanned aerial vehicle (UAV) are adapted to tow a cable. The fuselage of the UAV includes a mounting surface. The hook assembly includes a first member and a second member. The first member has a distal end, and a proximate end mounted on and projecting transverse the mounting surface. The second member is mounted on the distal end and projects transverse thereto. The cable is engageable with the hook assembly.

### FIELD OF THE INVENTION

This invention concerns a hook assembly attachable to an unmanned aerial vehicle for towing a cable.

### BACKGROUND

Remotely piloted unmanned aerial vehicles (UAVs) are used to pull cables over terrain otherwise difficult to traverse, such as rivers, ravines and forests, to complete overhead conductor connections, for example. A pull attachment device mounted to the underside of the UAV engages the cable to effect towing. The attachment device typically has multiple moving parts, mechanisms to move the parts, electronics to control the mechanisms, and batteries to power the electronics and mechanisms. The moving parts, electronics, mechanisms and batteries add weight to the combined UAV and pull attachment device, and add operational complexity.

There is clearly a need for attachments devices mountable on UAVs which may decrease the weight of the combined UAV and attachment device, simplify the operation, and minimize moving parts, mechanisms, electronics and batteries.

### SUMMARY

This invention concerns, in combination, a hook assembly and an unmanned aerial vehicle (UAV). In an example embodiment, the combination is adapted to tow a cable. The UAV comprises a mounting surface. The hook assembly comprises a first member and a second member. The first member has a distal end and a proximate end mounted on and projecting transverse to the mounting surface. The second member is mounted on the distal end and projects transverse thereto. The cable is engageable with the hook assembly.

In an example, the hook assembly further comprises a lanyard having a first end that is removably engageable with the hook assembly and a second end that is attachable to the cable. In a particular example, the lanyard further comprises a first loop positioned on the first end thereof, and a second loop positioned on the second end thereof.

As an example, the hook assembly comprises a weight attached to the lanyard. In a particular example, the hook assembly further comprises a carbineer attached to the second loop.

In an example, the second member is angularly oriented relative to the mounting surface. As an example, the UAV further comprises a fuselage. The mounting surface is located on the fuselage. In a particular example, the proximate end is attached to a base attachable to the fuselage. In another particular example, the base comprises a plate defining two slots therein. The slots receive a strap, which surrounds the fuselage for attaching the base to the mounting surface. As an example, the strap comprises ends joined via hook and look fasteners.

As an example, the UAV further comprises a fuselage, a leg, and a foot. The leg extends from the fuselage. The foot is attached to a terminal end of the leg. The mounting surface is located on an intersecting portion of the leg and the foot. In a particular example, the proximate end is attached to a base attachable to the mounting surface. In another particular example, the base comprises a plate defining two slots therein. The slots receive a strap surrounding the leg and the foot for attaching the base to the mounting surface.

In an example, the hook assembly has an “L” shaped profile. As an example, the hook assembly has a “J” profile.

This invention further concerns a hook assembly attachable to a UAV. In an example embodiment, the UAV comprises a mounting surface. The hook assembly is adapted to tow a cable. The hook assembly comprises a first member and a second member. The first member has a distal end and a proximate end mounted on and projecting transversely to the mounting surface. The second member is mounted on the distal end and projects transverse thereto. The cable is engageable with the hook assembly.

In an example, the hook assembly further comprises a lanyard having a first end removably engageable with the hook assembly and a second end attachable to the cable. In a particular example, the lanyard further comprises a first loop and a second loop. The first loop is positioned on the first end thereof and the second loop is positioned on the second end thereof. In a particular example, the hook assembly comprises a weight attached to the lanyard. In another particular example, the hook assembly further comprises a carbineer attached to the second loop.

As an example, the second member is angularly oriented relative to the mounting surface. In an example, the proximate end is attached to a base attachable to the mounting surface. As an example, the proximate end is attached to a base attachable to the mounting surface. In a particular example, the base comprises a plate defining two slots. The slots receive a strap which surrounds the fuselage for attaching the base to the mounting surface. In a particular example, the strip comprises ends joined via hook and loop fasteners.

In an example the hook assembly has an “L” shaped profile. As an example, the hook assembly has a “J” shaped profile.

This invention further concerns a kit adapted for towing a cable attachable to an unmanned aerial vehicle (UAV). In this example embodiment, the UAV comprises a mounting surface. The kit comprises in combination a hook assembly, a lanyard, a carbineer and a strap. The hook assembly comprises a base, a first member and a second member. The base comprises a plate defining two slots therein. The first member has a distal end and a proximate end mounted on and projecting transversely to the mounting surface. The second member is mounted on the distal end and projects transverse thereto. The lanyard comprises a first end and a second end. The first end is removably engageable with the hook assembly. The carabineer attaches to the second end. The carbineer is attachable to the cable. The strap is for attaching the base to the mounting surface.

As an example, the UAV further comprises a fuselage. The mounting surface is located on the fuselage. The strip surrounds the fuselage for attaching the base to the mounting surface.

In an example, the UAV further comprises a fuselage, a leg, and a foot. The leg extends from the fuselage. The foot is attached to a terminal end of the leg. The mounting surface is located on an intersecting portion of the leg and the foot. The strap surrounds the intersecting portion for attaching the base to the mounting surface. In a particular example, the second member is oriented in a direction toward the fuselage.

As an example, the lanyard further comprises a first loop positioned on the first end thereof, and a second loop positioned on the second end thereof. In an example, the carbineer is attached to the second loop.

As an example, the second member is oriented in a direction toward the fuselage.

In an example, the second member is angularly oriented relatively to the second mounting surface.

As an example, the proximate end is attached to the base. In a particular example, the slots receive the strap. In another particular example, the strap comprises ends joined via hook and loop fasteners.

In an example, the hook assembly has an “L” shaped profile. As an example, the hook assembly has a “J” shaped profile.

The invention also concerns a method of positioning a cable attachable to a mounting surface of an unmanned aerial vehicle (UAV). The method comprises:
attaching a hook assembly to the UAV, the hook assembly having a lanyard;
engaging the cable to the lanyard, the lanyard having a first and second end, the cable engaging the second end;
looping the first end over the hook assembly;
towing the cable with the UAV;
maneuvering the UAV so that the lanyard is releasable from the hook assembly; and
releasing the lanyard.

As an example, the maneuvering step comprises maintaining the UAV stationary. In an example, the maneuvering step comprises reversing a direction of the UAV. As an example, the maneuvering step comprises pitching the UAV.

### BRIEF DESCRIPTION OF DRAWINGS

FIG. 1 is an isometric view of a an example combination hook assembly and UAV according to this invention;

FIG. 2 is an isometric view of an example hook assembly according to the invention;

FIG. 3 is a side view of a hook assembly according to the invention;

FIG. 4 is a rear view of a hook assembly according to the invention;

FIG. 5 is an isometric view of a hook assembly according to the invention;

FIG. 6 is a side view of a hook assembly according to the invention;

FIG. 7 is a side view of a hook assembly according to the invention;

FIG. 8 is an isometric view of a kit according to the invention;

FIG. 9 is a flow chart of an example method of positioning a cable according to the invention;

FIG. 10 is a flow chart depicting a portion of an example method of positioning a cable;

FIG. 11 is a flow chart depicting a portion of an example method of positioning a cable;

FIG. 12 is a flow chart depicting a portion of an example method of positioning a cable;

FIG. 13 is a plan view of a hook assembly according to the invention;

FIG. 14 is an isometric view of an example combination hook assembly and UAV according to this invention;

FIG. 15 is an isometric view of a portion of the example combination hook assembly and UAV; and

FIG. 16 is an isometric view of a portion of the example combination hook assembly and UAV.

### DETAILED DESCRIPTIONS

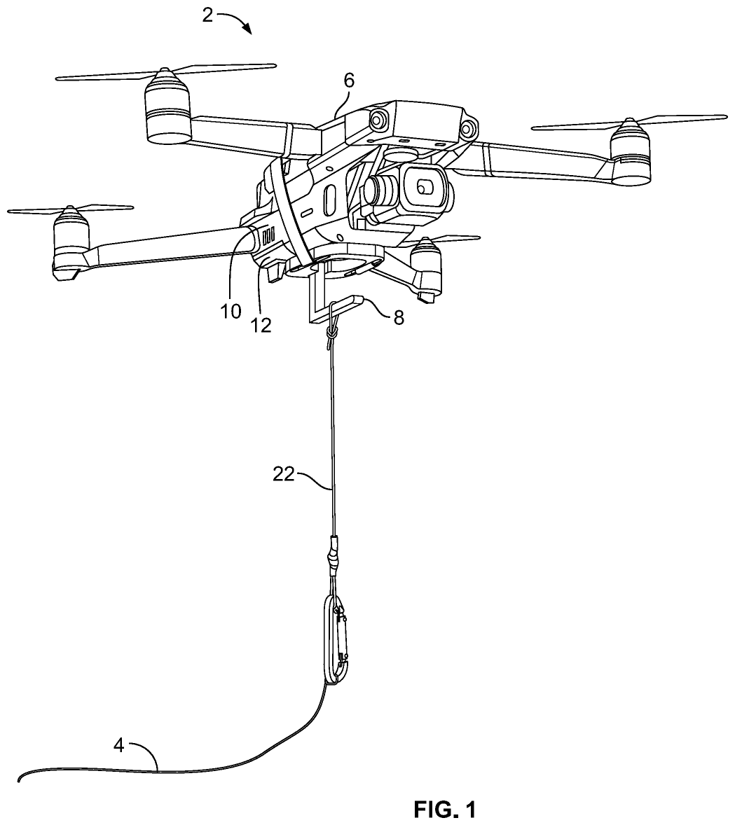

An example of a combination hook assembly and unmanned aerial vehicle (UAV) 2 adapted for towing a cable 4 according to the invention is shown in FIG. 1. The combination 2 comprises a UAV 6 and a hook assembly 8. The cable 4 is engageable with the hook assembly 8. The UAV 6 comprises a mounting surface 12.

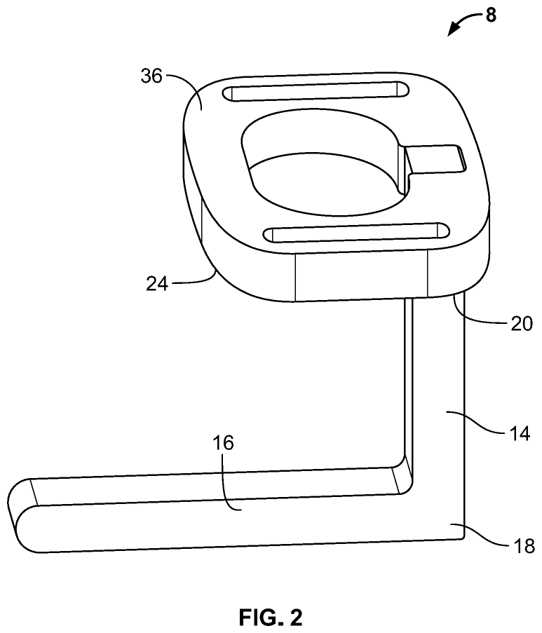

As shown in FIG. 2, the hook assembly 8 comprises a first member 14 and a second member 16. The first member 14 has a distal end 18 and a proximate end 20. The proximate end 20 is mounted on and projects transverse to the mounting surface 12 (FIG. 1).

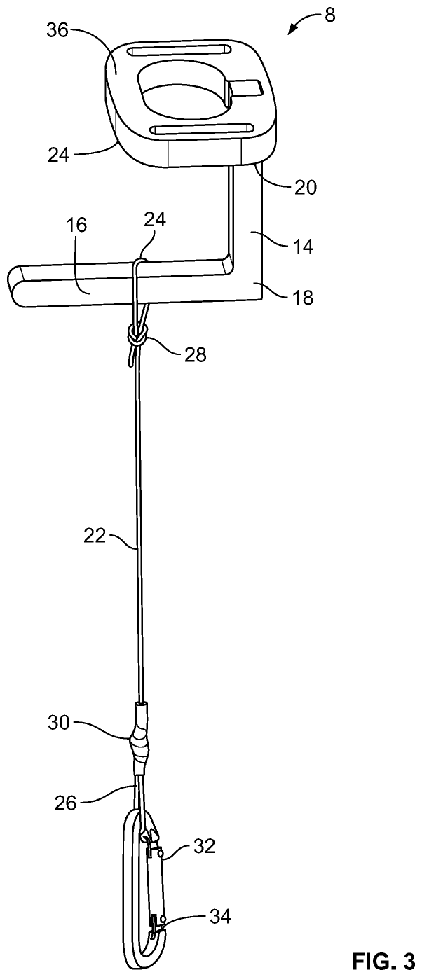

FIG. 3 shows an example of the hook assembly 8 further including a lanyard 22. The lanyard 22 has first and second ends 24 and 26. The first end 24 is removably engageable with the hook assembly 8 and the second end 26 is attachable to the cable 4 (FIG. 1). The lanyard 22 also comprises a first loop 28 and a second loop 30. The first loop 28 is positioned on the first end 24 and the second loop 30 is positioned on the second end 26. In this example, the first loop 28 attaches to the hook assembly 8 by engaging the second member 16. The lanyard 22 advantageously acts as a telltale, increasing the visibility of the combination 2 when the UAV is in flight, and offsets the cable from the fuselage 12 (see FIG. 1).

As further shown in FIG. 3, the hook assembly 8 may comprise a weight 32 attached to the lanyard 22. The hook assembly may also comprise a carbineer 34 attached to the second loop 30. The carbineer 34 in this example advantageously serves as the weight 32. The carbineer 34 advantageously may be used to attach the cable 4 to the hook assembly 8, as shown in FIG. 1.

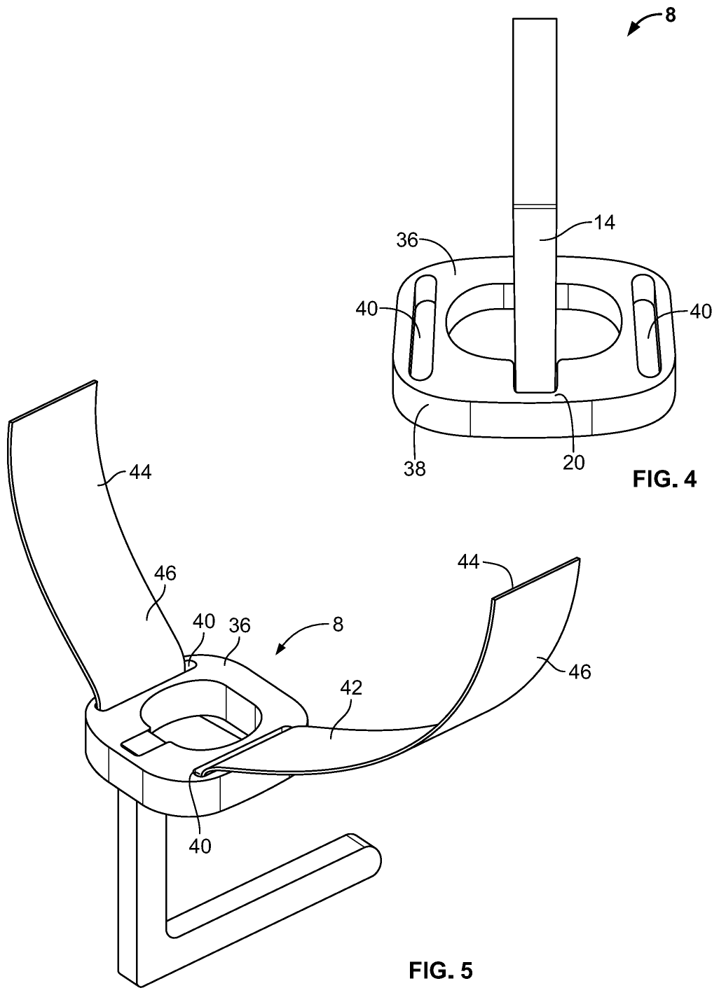

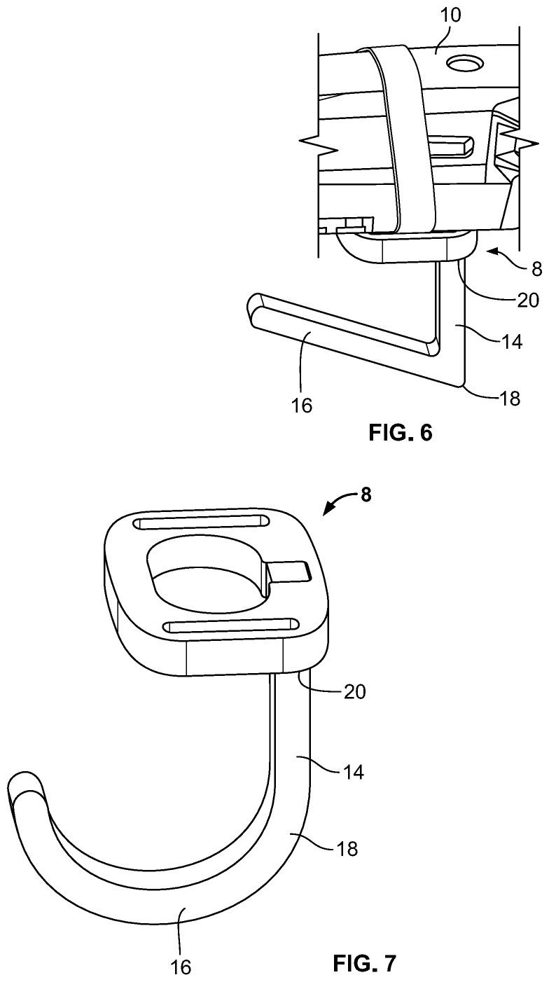

FIGS. 4 and 5 show an example of the hook assembly 8 with the proximate end 20 of the first member 14 attached to a base 36. The UAV further comprises a fuselage 10 (see FIGS. 1 and 6). In this example, the mounting surface 12 is located on the fuselage 10. The base 36 is attachable to the fuselage 10 (see FIGS. 1 and 6). As shown in FIG. 4, the base 36 comprises a plate 38 defining two slots 40 therein. The slots 40 receive a strap 42, as shown in FIG. 5. The strap 42 surrounds the fuselage 10 and attaches the base 36 to the mounting surface 12 (see FIGS. 1 and 6). The strap 42 may comprise ends 44 joined via hook and loop fasteners 46.

Various example embodiments of the hook assembly 8 are shown in FIGS. 2, 6 and 7. FIG. 2 shows an example of the hook assembly 8 that may have an “L” shaped profile. As shown in FIG. 6, another example embodiment of the hook assembly 8 may comprise the second member angularly oriented relative to the mounting surface. FIG. 7 shows a further example embodiment of the hook assembly 8 that may have a “J” shaped profile.

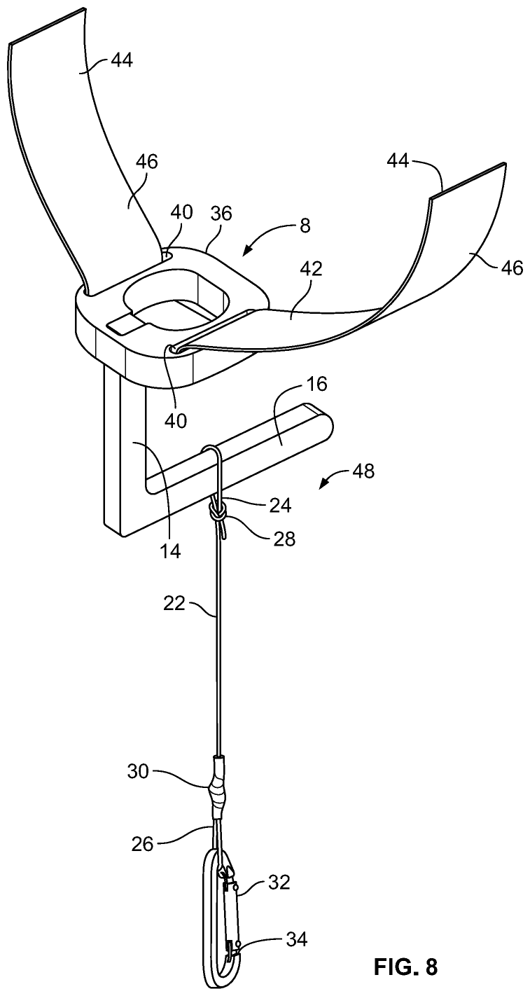

FIG. 8 shows an example embodiment of a hook assembly kit 48 attachable to the mounting surface 12 of the UAV 6 for towing a cable 4 (see FIG. 1). As shown in FIG. 8, the kit 48 may comprise, one or more of the following components in combination, the hook assembly 8, the lanyard 22, the carbineer 34, and the strap 42 as described above.

As seen in FIG. 1, in use, the kit 48, is attached to a UAV 6. As shown in FIG. 5, the strap 42 is attached to the slots 40, in the plate 38 of base 36. The ends 44 of strap 42 include hook and loop fasteners 46, in this example. FIG. 1 shows the strap 42 wrapped around the mounting surface 12 of the UAV 6 and the hook and loop fasteners 46 joining the ends 44, thereby securing the hook assembly 8 to the mounting surface 12. In this example, the base 36 (see FIGS. 4 and 5) of the hook assembly 8 is secured to the mounting surface 12, which is located on the fuselage 10. As shown in FIG. 8, the carbineer 34 is attached to the second end 26 of lanyard 22, and the cable 4 is attached to the carbineer 34 (FIG. 1). The first end 24 of lanyard 22 is attached to the hook assembly 8.

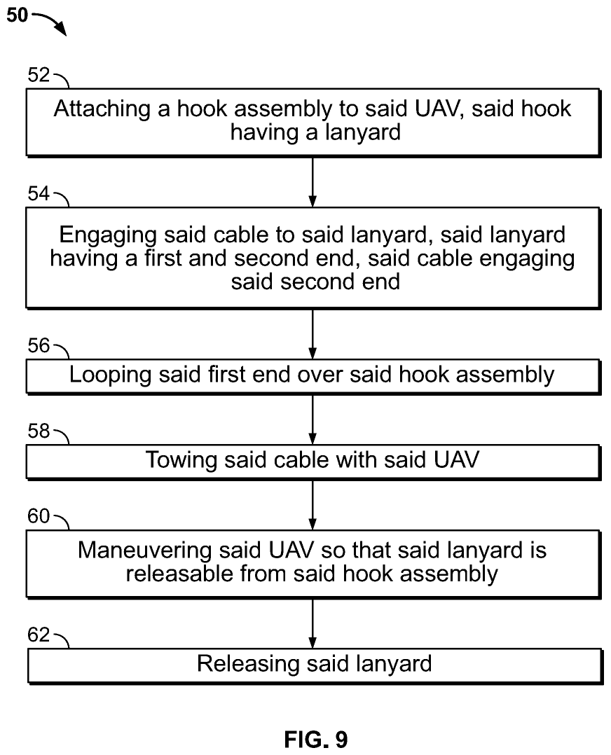

An example method 50 for towing the cable 4 attachable to the mounting surface of a UAV (see FIG. 1) is shown in FIG. 9. The method 50 begins with step 52 of attaching a hook assembly 8 to the UAV 6. The lanyard 22 has first and second ends 24 and 26 (see FIG. 8). The method 50 continues with step 54 of engaging the cable 4 with a lanyard 22 (FIG. 8), step 56 of looping the first end 24 of the lanyard 22 over the hook assembly 8, and step 58 of towing the cable 4 with the UAV 6. Method 50 proceeds with step 60 of maneuvering the UAV 6 so that the lanyard 22 is releasable from the hook assembly 8. Method 50 concludes with step 62 of releasing the lanyard 22.

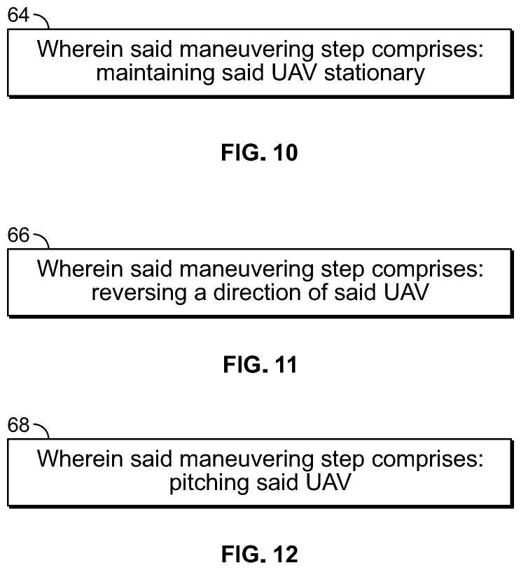

FIG. 10 illustrates a flow chart depicting a portion of method 50 where the maneuvering step 60 comprises step 64 of maintaining the UAV 6 stationary while towing the cable 4 (FIG. 1) thereby enabling release of the lanyard 22 from the hook assembly 8. Step 64 may be implemented by commanding the UAV 6 to remain stationary, hovering local to the desired final towing location, for example. With the UAV 6 stationary the lanyard 22 with the cable 4 attached may be released according the step 62.

FIG. 11 illustrates another flow chart depicting a portion of method 50 where the maneuvering step 60 comprises step 66 of reversing a direction of the UAV 6 while towing the cable 4 thereby enabling release of the lanyard 22 from the hook assembly 8. Step 66 may be implemented by commanding the UAV 6 to move in reverse, slightly away from the final towing location, so that the lanyard with the cable attached may be release according to step 62.

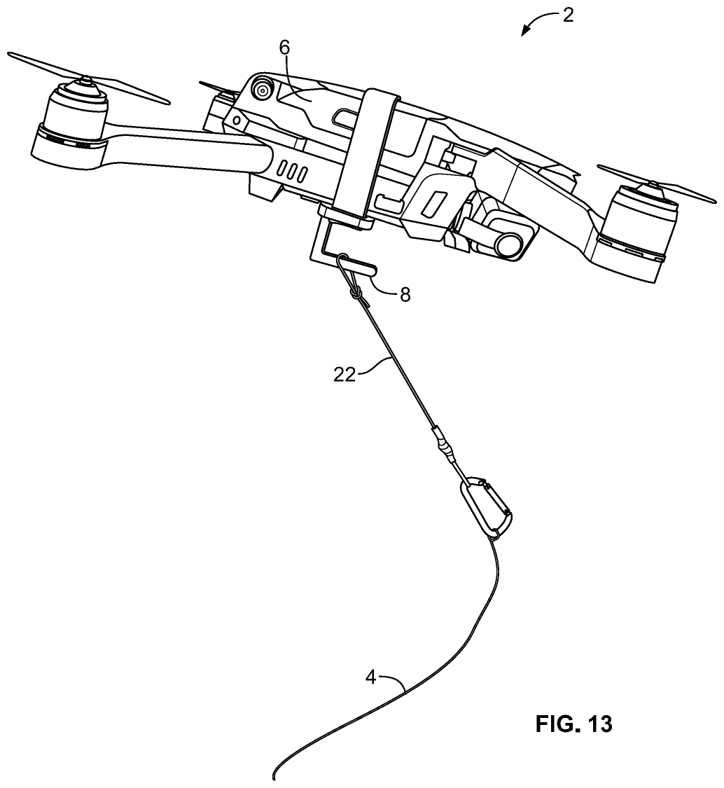

FIG. 12 illustrates a further flow chart depicting a portion of method 50 where the maneuvering step 60 comprises step 68 of pitching the UAV 6 while towing the cable 6 thereby enabling release of the lanyard 22 from the hook assembly 8. Step 68 may be implemented by commanding the UAV to pitch about a direction transverse to the direction of travel, local to the final towing destination for example, as shown in FIG. 13. As the UAV pitches the lanyard 22 with the cable 4 attached advantageously may be released from the hook assembly 8 according to step 62.

The implementation of step 62 of releasing the lanyard 22 may be accomplished via the maneuvering step detailed above, or via a combination of the maneuvering step and a physical removal of the lanyard. The physical removal of the lanyard may be accomplished by a technician local to the final towing destination disconnecting the lanyard 22 from the hook assembly 8.

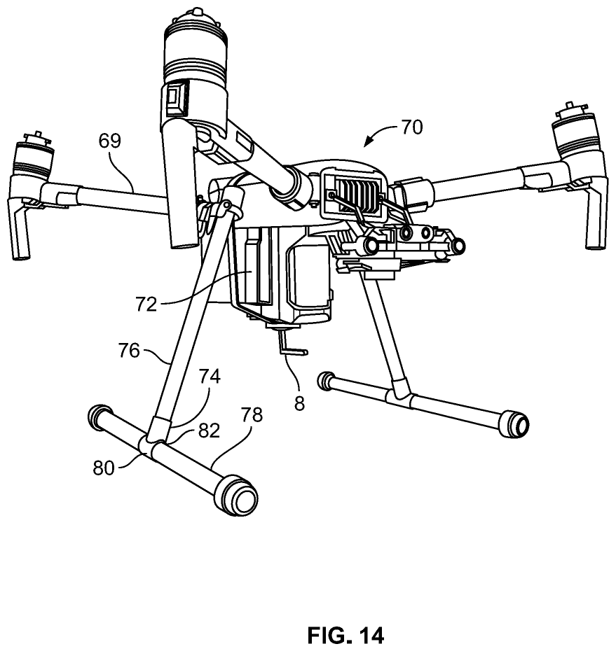

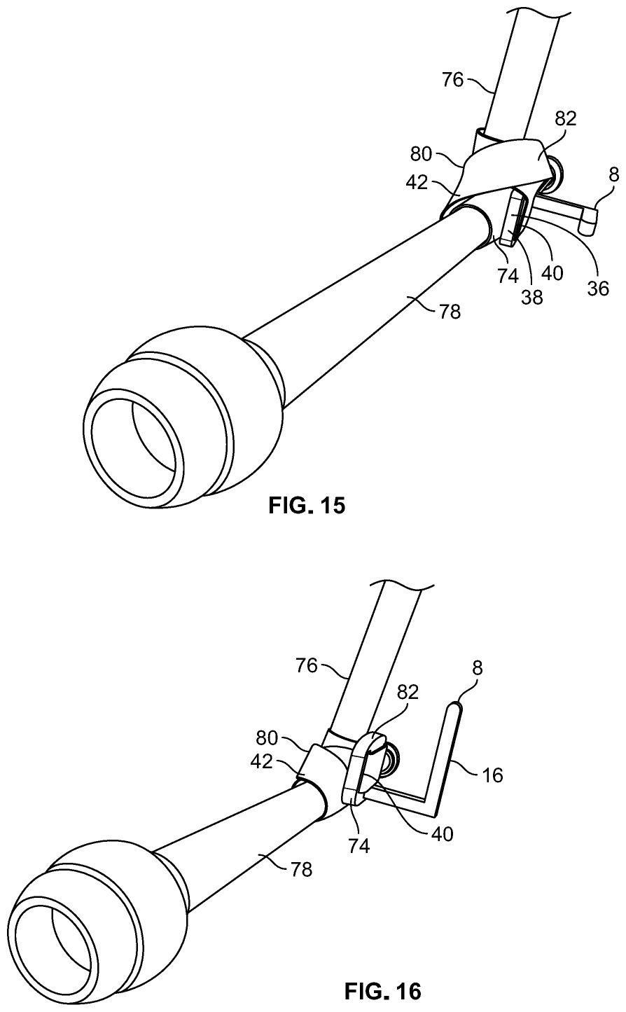

An additional example of a combination hook assembly 8 and UAV 69 adapted for towing a cable according to the invention is shown in FIGS. 14 and 15. The combination 70 comprises a UAV 69 and a hook assembly 8 (see FIG. 5). The UAV 69 comprises a fuselage 72, a mounting surface 74, a leg 76 extending from the fuselage 72 and a foot 78. As shown in FIG. 15, the foot 78 is attached to a terminal end 80 of the leg 76. The mounting surface 74 is located on an intersecting portion 82 of the leg 76 and the foot 78.

FIG. 15 shows an example of the hook assembly 8 with the base 36 attached to the mounting surface 74 of the UAV 69. The base 36 comprising the plate 38 defines two slots 40 therein. The slots 40 receive the strap 42 (see FIG. 5), a portion of which is showing in FIG. 15. The strap 42 surrounds the intersecting portion 82 and attaches the base 36 to the mounting surface 74.

FIG. 16 shows an example of the hook assembly 8 with the second member 16 oriented in a direction toward the fuselage 72 of UAV 69. In use, when the lanyard 22 is attached to hook 8 (see FIG. 6) with the second member 16 oriented angularly in the direction toward the fuselage 72, the release of lanyard 22 must be conducted manually, because the release of the cable will not be possible by solely maneuvering the UAV.

The combination, kit, and method of towing a cable according to the invention are expected to provide attachment devices mountable on UAVs which can decrease the weight, simplify the operation of the UAV, and minimize moving parts, electronics or batteries.

What is claimed is:

1. In combination, a hook assembly and an unmanned aerial vehicle (UAV), said combination adapted to tow a cable, said UAV comprising:
a mounting surface,
said hook assembly comprising:
a first member having a distal end and a proximate end mounted on and projecting transverse to said mounting surface; and
a second member mounted on said distal end and projecting transverse thereto,
wherein said cable is engageable with said hook assembly.

2. The combination according to claim 1, wherein said hook assembly further comprises a lanyard having a first end removably engageable with said hook assembly, and a second end attachable to said cable.

3. The combination according to claim 2, wherein said lanyard further comprises:
a first loop positioned on said first end thereof; and
a second loop positioned on said second end thereof.

4. The combination according to claim 2, wherein said hook assembly further comprises a weight attached to said lanyard.

5. The combination according to claim 4, wherein said hook assembly further comprises a carbineer attached to said second loop.

6. The combination according to claim 1, wherein said second member is angularly oriented relatively to said mounting surface.

7. The combination according to claim 1, wherein said UAV further comprises a fuselage, said mounting surface being located on said fuselage.

8. The combination according to claim 1, said UAV further comprising:
a fuselage;
a leg extending from said fuselage; and
a foot, attached to a terminal end of said leg;
said mounting surface being located on an intersecting portion of said leg and said foot.

9. The combination according to claim 7, wherein said proximate end is attached to a base attachable to said fuselage.

10. The combination according to claim 9, wherein said base comprises a plate defining two slots therein, said slots receiving a strap surrounding said fuselage for attaching said base to said mounting surface.

11. The combination according to claim 10, wherein said strap comprises ends joined via hook and loop fasteners.

12. The combination according to claim 1, wherein said hook assembly has an “L” shaped profile.

13. The combination according to claim 1, wherein said hook assembly has a “J” shaped profile.

14. The combination according to claim 8, wherein said proximate end is attached to a base attachable to said mounting surface.

15. The combination according to claim 14, wherein said base comprises a plate defining two slots therein, said slots receiving a strap surrounding said leg and said foot for attaching said base to said mounting surface.

16. A hook assembly attachable to an unmanned aerial vehicle (UAV), said UAV comprising a mounting surface, said hook assembly adapted to tow a cable, said hook assembly comprising:
a first member having a distal end and a proximate end mounted on and projecting transversely to said mounting surface; and
a second member mounted on said distal end and projecting transverse thereto,
wherein said cable is engageable with said hook assembly.

17. The hook assembly according to claim 16, wherein said hook assembly further comprises a lanyard having a first end removably engageable with said hook assembly, and a second end attachable to said cable.

18. The hook assembly according to claim 17, wherein said lanyard further comprises:
a first loop positioned on said first end thereof; and
a second loop positioned on said second end thereof.

19. The hook assembly according to claim 17, wherein said hook assembly comprises a weight attached to said lanyard.

20. The hook assembly according to claim 19, wherein said hook assembly further comprises a carbineer attached to said second loop.

21. The hook assembly according to claim 16, wherein said second member is angularly oriented relatively to said mounting surface.

22. The hook assembly according to claim 16, wherein said proximate end is attached to a base attachable to said mounting surface.

23. The hook assembly according to claim 22, wherein said base comprises a plate defining two slots therein, said slots receiving a strap surrounding said fuselage for attaching said base to said mounting surface.

24. The hook assembly according to claim 23, wherein said strap comprises ends joined via hook and loop fasteners.

25. The hook assembly according to claim 17, wherein said hook assembly has an “L” shaped profile.

26. The hook assembly according to claim 17, wherein said hook assembly has a “J” shaped profile.

27. A kit adapted for towing a cable attachable to an unmanned aerial vehicle (UAV), said UAV comprising a mounting surface, said kit comprising, in combination:
a hook assembly comprising:
a base comprising a plate defining two slots therein;
a first member having a distal end and a proximate end mounted on and projecting transversely to said mounting surface; and
a second member mounted on said distal end and projecting transverse thereto;
a lanyard comprising:
a first end removably engageable with said hook assembly and;
a second end;
a carbineer attachable to said second end, said carbineer attachable to said cable; and
a strap for attaching said base to said mounting surface.

28. The kit according to claim 27, wherein said UAV further comprises a fuselage, said mounting surface being located on said fuselage, said strap surrounding said fuselage for attaching said base to said mounting surface.

29. The kit according to claim 27, wherein said UAV further comprising:
a fuselage;
a leg extending from said fuselage; and
a foot, attached to a terminal end of said leg;
said mounting surface being located on an intersecting portion of said leg and said foot, said strap surrounding said intersecting portion for attaching said base to said mounting surface.

30. The kit according to claim 27, wherein said lanyard further comprises:
a first loop positioned on said first end thereof; and
a second loop positioned on said second end thereof.

31. The kit according to claim 27, wherein said carbineer is attached to said second loop.

32. The kit according to claim 27, wherein said second member is angularly oriented relatively to said mounting surface.

33. The kit according to claim 27, wherein said proximate end is attached to said base.

34. The kit according to claim 33, wherein said slots receive said strap.

35. The kit according to claim 34, wherein said strap comprises ends joined via hook and loop fasteners.

36. The kit according to claim 27, wherein said hook assembly has an “L” shaped profile.

37. The kit according to claim 27, wherein said hook assembly has a “J” shaped profile.

38. The kit according to claim 29, wherein said second member is oriented in a direction toward said fuselage.

39. A method of positioning a cable attachable to a mounting surface of an unmanned aerial vehicle (UAV), said method comprising:
attaching a hook assembly to said UAV, said hook assembly having a lanyard;
engaging said cable to said lanyard, said lanyard having a first and second end, said cable engaging said second end;
looping said first end over said hook assembly;
towing said cable with said UAV;
maneuvering said UAV so that said lanyard is releasable from said hook assembly; and
releasing said lanyard.

40. The method according to claim 39, wherein said maneuvering step comprises maintaining said UAV stationary.

41. The method according to claim 39, wherein said maneuvering step comprises reversing a direction of said UAV.

42. The method according to claim 39, wherein said maneuvering step comprises pitching said UAV.
